(19) United States
(12) Patent Application Publication
(10) Pub. No.: US 2010/0309054 A1
(43) Pub. Date: Dec. 9, 2010

(54) Method for Increasing the Location Accuracy for Unsynchronized Radio Subscribers

(75) Inventors: Markus Pichler, Linz (AT); Stefan Schwarzer, Munchen (DE); Claus Seisenberger, Neufrannhofen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/678,004

(22) PCT Filed: Jul. 29, 2008
(86) PCT No.: PCT/EP2008/059907

§ 371 Date: Mar. 25, 2010

(30) Foreign Application Priority Data
Sep. 13, 2007 (DE) 10 2007 043 649.3

(51) Int. Cl. G01S 5/06

(52) U.S. Cl. 342/394

(57) ABSTRACT

The invention relates to a method for increasing the location accuracy for unsynchronized radio subscribers, in which phase evaluation is used to ascertain the position of a transmitter which is to be located. The transmitter to be located and a further transmitter, whose location is known, respectively send a sequence of N signals to at least two receivers, wherein the transmission channel to be used for transmitting a signal is varied, in line with the invention, on the basis of a prescribed, symmetrical hopping scheme. The advantageous characteristics of the hopping scheme and the additional application of the TDOA (time difference of arrival) principle mean that highly accurate location is possible.

### CROSS-REFERENCE TO RELATED APPLICATION

This is a U.S. national stage of International Application No. PCT/EP2008/059907, filed on 29 Jul. 2008. Priority is claimed on German Application No. 10 2007 043 649.3, filed 13 Sep. 2007.

### BACKGROUND OF THE INVENTION

Time difference of arrival (TDOA) methods are normally used for locating an object fitted with a transmitter. With these methods, the object to be located transmits a signal which is received by several fixed receivers. The position of the object relative to the receivers can be determined by triangulation methods from the differences between the arrival times.

A fundamental requirement for the known TDOA method is that the transmitters and/or receivers are synchronized in time. If this is not the case, corresponding errors occur when determining the position. Although synchronization measures are known from the prior art, they are linked with considerable financial and material costs. For example, the satellites in the Global Positioning System (GPS) are fitted with high-accuracy atomic clocks for this reason. The satellites are also able to exchange necessary synchronization data with one another for synchronization purposes.

A method for transit-time-based location (TDOA method) of an unsynchronized radio subscriber is described in the German patent application DE 10 2006 040 497 A1. This method uses at least two transmitters and at least two receivers to provide an estimated position value for one of the transmitters. In doing so, the receivers and at least one transmitter (reference transmitter) must have a known location while the remaining transmitters are to be located. The number of receivers determines the number of dimensions in which location can be performed. Because of the reference transmitter, synchronization of the system subscribers is superfluous.

As has been shown, the location accuracy can be increased by evaluating a signal phase. In the phase evaluation, use is made of the fact that when a transmitter transmits signals to different frequency interpolation points, the distance from the transmitter can be determined from the measurement of the phase positions of the signals at the receiver. A basic requirement for this, however, is that the phase relationship is known or constant when transmitting, and that transmitter and receiver are synchronized in time. The received phase positions φₙ at the frequency interpolation points fₙ for a signal transit time τ_{R} are given by: φₙ=2π·fₙ·τ_{R}

The required distance R can be determined with the help of the relationship R=c·τ_{R} where c is the signal propagation speed. In doing so, it must be noted that the phase is only unambiguous in the range between 0 and 2π. Depending on how far apart the frequency interpolation fₙ points are, this results in a more or less wide unambiguity range of the measurement. Theoretically, measurements are made with absolute unambiguity when the frequency interpolation points are infinitely close together.

In spite of the disadvantage of ambiguity, phase evaluation has the advantage of a potentially higher accuracy of location: The total bandwidth enclosed between the lowest and highest frequency used for measurement is roughly inversely proportional to the mean error due to multipath propagation. Moreover, either an unambiguous but inaccurate time measurement or time correlation can be used to restore the unambiguity, as long as this is more accurate than the unambiguity range of the phase evaluation, or alternatively the result of a TDOA measurement can be used.

In DE 10 2006 040 497 A1, all transmitters transmit signals to different frequency interpolation points, the IEEE 802.15.4 communications standard being adopted for the signals which are used for location. This requires relatively narrow-band signals (approx. 2 MHz, 3 dB bandwidth) in the 2.45 GHz ISM band. If all 16 channels defined in the protocol are used, this results in a total enclosed bandwidth of 80 MHz and an unambiguity range dₑᵢₙ=c/(2·f_{d}) of 30 m (speed of light c, channel spacing f_{d}). However, because the 16 channels can never be used simultaneously but only sequentially, several problems arise:

All transmitters are unsynchronized and therefore have different time and frequency offsets. The signals are transmitted at different points in time and with different frequency errors. As a result of these two circumstances, the phases of the signals received by the receivers are shifted in comparison to the idealized observation described above.

As all receivers are also unsynchronized and likewise have different time and frequency offsets, the arrival times of the signals are measured in different time axes. This also applies to the phase positions, because the clocks in the receivers have to be used to mix down the received signals.

Additional errors result from a movement of a transmitter to be located, as the individual frequencies are used sequentially in time. A movement during the measurement does not lead to a linear increase in phase with frequency but to an increase of a higher order (quadratic or higher). An incorrect distance is usually measured as a result.

The advantages of phase evaluation cannot therefore be utilized.

However, a range of possibilities is conceivable for synchronizing the transmitters and receivers such that phase evaluation can be applied:

Synchronization of the transmitters: After this, the transmitters operate in the same time and frequency axis and the receivers are able to determine the difference phases even when they themselves are unsynchronized (e.g., GPS).

Synchronization of the receivers: After this, the receivers use the same frequency and phase positions for mixing down the received signals and are able to determine the difference phases of the unsynchronized transmitters (e.g., location system from Abatec or the LPR-B from Symeo). The majority of location solutions use synchronized receivers.

Simultaneous occupation of several frequency interpolation points: This is possible with the OFDM communications method, for example, with which there is a really wide received signal from many individual carriers. As the whole frequency range is occupied simultaneously, the individual carriers have a phase relationship to one another.

### SUMMARY OF THE INVENTION

It is therefore an object of the invention to provide a method which enables the location accuracy of unsynchronized radio subscribers to be increased.

This and other objects and advantages are achieved by providing a location method in which it is assumed that an increase in the location accuracy in a system of unsynchronized radio subscribers, for example, ZigBee or Bluetooth network, is possible based on the use of a phase evaluation. In particular, such an increase in accuracy is also possible when the frequency interpolation points for transmitting a signal are not occupied simultaneously but sequentially. In addition, on the one hand, the TDOA measuring principle described in DE 10 2006 040 497 A1 is a necessary requirement, where a transmitter with a known position is used as a reference transmitter, with respect to which the time and phase differences of the other transmitters are determined. Furthermore, drifting clocks in the receivers and a possible movement of the transmitter to be located necessitate further measures. In particular, the phase evaluation provides very good results when the frequency interpolation points are not accessed in a random or chaotic order but in accordance with a defined, symmetrical hopping scheme.

The hopping scheme specifies the order of the frequency interpolation points or channels to be used for transmitting the signals. A channel kₙ is described by a mean frequency f(kₙ) and a width, and is used for transmitting a signal in the form of an electromagnetic wave. As a rule, a series of such channels, which are usually associated with one another in blocks, is defined for each communications standard, where the mean frequencies of the channels of a block have a constant spacing f_{d}. The channel definition in IEEE 802.15.4 (PHY layer of ZigBee), for example, includes a block of 16 channels, the mean frequencies of which lie between 2405 MHz and 2480 MHz for a channel spacing f_{d}=5 MHz.

In accordance with the invention, an object to be located transmits a sequence of N signals Sₙ. The signals to be transmitted over channel kₙ consist of a carrier signal, the frequency of which is prescribed by the channel kₙ, and a data stream modulated thereon. At the same time, transmission channels kₙ and kₙ₊₁ are selected for consecutive signals Sₙ and Sₙ₊₁ according to a predetermined hopping scheme. The hopping scheme is compiled in accordance with a special formation law, which is characterized in particular by its symmetry.

The formation law can be compiled based on the following definitions:

Let I be the number of transmitters, where I is an integer and greater than or equal to 2.

Let N be the number of hops (i.e. N determines the length of the hopping scheme), where N is an integer, even and greater than or equal to 4.

Let the channel to be used in hop n by the transmitter Ti be kₙ^{Ti} for all i=0, . . . I−1 and n=0, . . . N−1.

Let the transmission time for hop n of the transmitter Ti be tₙ^{Ti} for all i=0, . . . I−1 and n=0, . . . N−1.

Let the difference between the phase of the data stream and the phase of the carrier signal in channel kn of the transmitter Ti be φ^{Ti}(kₙ) for all i=0, . . . I−1 and 1 n=0, . . . N−1.

Based on this, the hopping scheme is produced in accordance with the following rules:

a) The hopping schemes are symmetrical about their midpoint for all transmitters Ti:

kₙ^{Ti}=k_{N-n-1}^{Ti}∀i=0, . . . I−1̂n=0, . . . N/2−1

b) Two or more transmitters may never use the same channel kₙ at the same time:

kₙ^{Ti}≠kₙ^{Tj}∀i,j=0, . . . I−1̂i≠ĵn=0, . . . N−1

For the case where two or more transmitters use different orthogonal codes (e.g., DSSS, spreading code) to spread their data streams spectrally (cf., CDMA), rule b) can be omitted and several transmitters can even occupy one channel simultaneously to minimize the spectral width. However, disadvantages are to be expected here (near-far problem, inadequate cross-correlation characteristics of the code).

c) The sets of all the channels kₙ used in the hopping scheme must be identical for all transmitters Ti, i.e., all transmitters must use the same channels kₙ in the course of the hopping; no transmitter may omit one or more channels kₙ compared with the other transmitters:

{k_{↓} [symbol] n [symbol] ^{↑}Ti|n=0, . . . N−1}={k_{↓} [symbol] n [symbol] ^{↑}Tj|n=0, . . . N−1}∀i,j=0, . . . I−1

This requirement may be breached if individual transmitters are to be located with lower accuracy. A subset of the channels kₙ which the fixed transmitter uses will then also be sufficient. However, the number of corresponding channels kₙ must never be less than 2.

d) The set of all the channels kₙ used in the hopping scheme forms a linear frequency ramp with constant frequency spacing f_{d} between the channels kₙ (if necessary after re-sorting and removal of multiple-accessed channels):

f(kₙ)=f₀+n·f_{d}∀n=0, . . . N−1

Here, f₀ is the lowest frequency to be used, e.g., f₀=2405 MHz for IEEE 802.15.4.

This rule is not necessarily compulsory. A channel can also be omitted without contravening the theory. However, this complicates the subsequent evaluation considerably.

e) The transmission times of a transmitter Ti must have a constant spacing over all hops in a hopping scheme:

tₙ₊₁^{Ti}−tₙ^{Ti}=tₙ^{Ti}−tₙ₋₁^{Ti}∀i=0, . . . I−1̂n=1, . . . N−2

This spacing, which is constant for one transmitter, can differ from one transmitter to another. The transmission times do not have to fulfill any further requirements, including those following a synchronization between the transmitters.

f) The relationship between the phase of the data stream and the phase of the carrier signal of each channel (kₙ) must be constant for a transmitter Ti:

φ^{Ti}(kₙ^{Ti})=φ^{Ti}(kₘ^{Ti})∀i=0, . . . I−1̂n=0, . . . N−1̂{m|kₘ^{Tj}=kₙ^{Tj}}

This requirement can be fulfilled in the transmitters with suitable devices for generating signals (e.g. integer PLL).

Rules a), e) and f) are absolutely essential; rules b), c) and d) can be disregarded under certain circumstances.

It is conceivable for a hopping scheme emanating from the described formation law to be expanded by adding additional channels before, in the midst of or after the hopping scheme, where however these channels are not used for measurement. A hopping scheme of this kind is likewise to be included in the scope of protection of the invention.

Other objects and features of the present invention will become apparent from the following detailed description considered in conjunction with the accompanying drawings. It is to be understood, however, that the drawings are designed solely for purposed of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described therein.

### BRIEF DESCRIPTION OF THE DRAWINGS

Further advantages, characteristics and details of the invention can be seen from the exemplary embodiment described below and with reference to the drawings, in which:

FIG. 1 shows in schematic representation an arrangement of a plurality of radio subscribers for locating one of the subscribers shown;

FIG. 2 shows a tabular overview of examples of hopping schemes according to the invention; and

FIG. 3 is a flow chart illustrating a method in accordance with an embodiment of the invention.

### DETAILED DESCRIPTION OF THE PREFERRED EMBODIMENTS

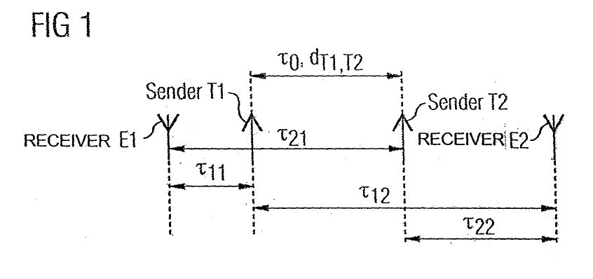

FIG. 1 shows a system for locating a transmitter T1 using an arrangement consisting of a further transmitter T2 and two receivers E1 and E2, where the system components T1, T2, E1 and E2 are unsynchronized. The positions of the receivers E1 and E2 and of the transmitter T2 are known. The arrangement shown enables a one-dimensional location of the transmitter T1 by determining the distance d_{T1,T2} of the transmitter T1 from the fixed and known transmitter T2 as described below.

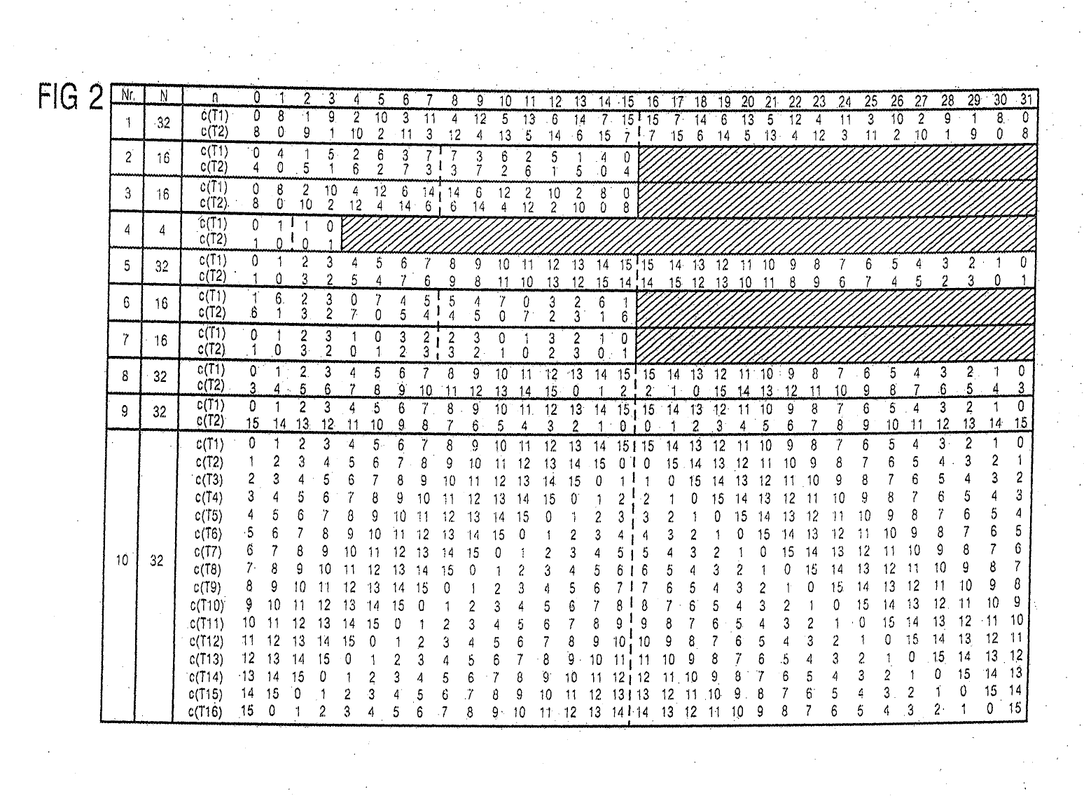

The transmitters T1 and T2 each transmit a sequence of N signals, where the signals are transmitted on channels kₙ (n=0, 1, . . . N−1). Typically, the channel kₙ used for the transmission is varied following a hopping scheme performed in accordance with the invention. If example No. 2 of the exemplary hopping schemes of FIG. 2 is used for the exemplary embodiment, transmitter T1 would transmit sequentially on channels 0, 4, 1, 5, 2, . . . while transmitter T2 would use a channel order 4, 0, 5, 1, 6, . . . .

The signals are received by receivers E1 and E2, where the transit time of the signal from transmitter Ti (i=1, 2) to receiver Ej (j=1, 2) is designated by A phase position dφᵢⱼ(kₙ) of the signal arriving from transmitter Ti is determined in receiver Ej for each channel kₙ. For this purpose, the absolute phase position φᵢⱼ(kₙ) of the signal transmitted from transmitter Ti on channel kₙ and received by receiver Ej is compared with the phase position φⱼ^{syn} of a synthetic signal stored in receiver Ej:

dφᵢⱼ(kₙ)=φᵢⱼ(kₙ)−φⱼ^{syn} (1)

Because of the symmetry of the hopping scheme, each channel kₙ is used by a transmitter at least twice. The phase positions dφᵢⱼ(kₙ) of those signals which have been transmitted from one of the transmitters Ti on the same channel kn are therefore arithmetically averaged in a receiver Ej. Exactly the same procedure is followed with the arrival times described below. This averaging is essential for the result, and utilizes the advantageous symmetry characteristics of the hopping scheme.

A phase difference Δφⱼ(kₙ)=dφ₁ⱼ(kₙ)−dφ₂ⱼ(kₙ) is in turn determined at the receiver Ej for each channel kₙ from the phase positions of the signals of the transmitters T1 and T2. Under ideal prerequisites, it could be assumed that the transmitters T1 and T2 transmit in phase, so that Δφⱼ(kₙ) would provide the actual phase difference between the signals received at the receiver Ej and would therefore be a measure of the spatial distance between T1 and T2. But as this is not usually so, particularly with unsynchronized transmitters, a further contribution d^{φ}^{ⱼ}^{⁰} must be taken into account in the phase difference:

Δφⱼ(kₙ)=dφ₁ⱼ(kₙ)−dφ₂ⱼ(kₙ)+d^{φ}^{ⱼ}^{⁰} (2)

However, this contribution d^{φ}^{ⱼ}^{⁰} can advantageously be eliminated by simply subtracting the phase differences measured at the two receivers:

Δφ^{tot}(kₙ)=Δφ₁(kₙ)−Δφ₂(kₙ)=dφ₁₁(kₙ)−dφ₂₁(kₙ)−dφ₁₂(kₙ)+dφ₂₂(kₙ) (3)

All errors resulting from frequency offsets of the subscribers and/or a linear movement component of a transmitter are eliminated in Δφ^{tot}(kₙ), which is materially due to the design of the hopping scheme. In particular:

Δφ^{tot}(kₙ)=−4π·f(kₙ)·τ₀+φ₀ (4)

Here, f(kₙ) is the mean frequency of the channel kₙ and τ₀ is the difference in transit times of the signals from T1 and T2 respectively to one of the receivers Ej, which in the case of electromagnetic waves corresponds to the time taken for light to travel between the transmitters T1 and T2. Finally, φ₀ is a constant term.

The over-determined system of equations (4) can be solved numerically, albeit the ambiguity of the phase information must be taken into account. As the mean frequencies f(kₙ) of the channels of the hopping scheme in accordance with the exemplary embodiments of the invention have been chosen to be equidistant thus resulting in a linear frequency ramp, the phase differences also result in a linear ramp (if necessary after an unwrap operation in which the phase is expanded by a multiple of 2π in a way that results in a linear ramp). The slope of the ramp is proportional to the transit time difference τ₀. The constant φ₀ means a shifting of the phase ramp but does not affect its slope. Likewise, making use of the equidistant mean frequencies f(kₙ) and within the framework of a further possible solution, an inverse discrete Fourier transformation is used on the complex expanded phase exp(iΔφ^{tot}(kₙ)). In the resulting absolute value spectrum, the required transit time difference τ₀ is located at the position of the absolute maximum. These considerations of the possible solutions are only valid without restriction when there are no constructive or destructive multipath propagations which can falsify the result to a greater or lesser extent.

The result of this determination of the transit time difference τ₀ is not unambiguous in the whole of the measuring range. Rather, an ambiguous result is achieved which is due to the ambiguity of the individual phase measurements. In order to choose the right unambiguity range, the transit time differences τ₀ determined by the phase evaluation described above are compared with a transit time difference τ₀^{TDOA} determined using a TDOA method.

In the TDOA method, the arrival times of the signals of the transmitters Ti at the receivers Ej are evaluated to be able to deduce from this the transit time of the signal between the transmitters T1 and T2, from which the distance d_{T1,T2} can be derived. In particular, the time dτᵢⱼ(kₙ) between the received signal and the stored synthetic signal is determined in the receiver Ej for each channel kₙ in turn.

By means of simple mathematical operations, which are equivalent to equations (1) to (3) of the phase evaluation method described above, this results in the required transit time difference value Δτ^{tot}(kₙ) for each channel kₙ:

Δτ^{tot}(kₙ)=dτ₁₁(kₙ)−dτ₂₁(kₙ)−dτ₁₂(kₙ)+dτ₂₂(kₙ) (5)

The transit time difference values are finally averaged across all channels kₙ to determine the required transit time difference τ₀^{TDOA}.

The correct transit time difference τ₀ is selected by defining the τ₀ which is closest to the averaged τ₀^{TDOA} as being the right one.

The required position of the transmitter T1 is calculated from the known position of the transmitter T2 and the distance d_{T1, T2} which, according to d_{T1,T2}=τ₀·c, depends on the transit time τ₀ and the speed of light c.

The addition of further receivers would enable expansion to two or three-dimensional locations by evaluating appropriately recorded data with the help of conventional methods, such as trilateration. A location of a plurality of transmitters could be realized by running through the described method several times.

FIG. 2 shows by way of example a selection of hopping schemes which have been produced with the formation law in accordance with the disclosed embodiments of the invention. Here, Examples 1 to 9 are shown for 2 transmitters T1 and T2 in each case, while 16 transmitters are provided in Example 10. As a general rule, the hopping schemes can be expanded by adding additional transmitters. The dotted lines in the individual schemes indicate the axes of symmetry.

Example 1 shows the scheme for 2 transmitters T1 and T2 with N=32. Channels 1 to 15 are arranged according to Rules a) to d) of the formation law. However, this is not the only way of arranging these channels (see Example 5).

Example 2 shows schemes for N=16 in which channels 0, 1, 2, . . . 7 are used.

In Example 3, N=16 likewise forms the basis, albeit use is made of channels 0, 2, 4 . . . 14. This shows that the channel spacing can be arbitrary but must remain constant over the whole hopping scheme.

In Example 4, N=4. Based on requirements a) and c) of the formation law, there cannot be a hopping scheme with a length less than 4.

Example 5 again shows N=32 but with a different sequence of channels than in Example 1. There are numerous further possibilities of arranging the channels, on account of which the depicted exemplary arrangements must not be considered to be conclusive.

Example 6 demonstrates channels 0 to 7 in a random arrangement for N=16. In Examples 1 to 5, the channels for transmitter T1 were accessed in a uniform pattern. In Example 6, on the other hand, the channel sequence for T1 has been determined by a random generator but without breaching Rules a) to d) of the formation law.

In Example 7, with N=16, channels 0 to 3 are each used not just twice but four times by each transmitter. Because of the averaging, this produces an additional improvement in the position estimation.

Example 8 shows channels 0 to 15 for N=32. In the preceding examples, two adjacent hops are always formed symmetrically point-by-point by swapping the channels to be used for transmitter T1 and transmitter T2. Example 8 shows an alternative arrangement.

Example 9 is the same as Example 8, but the channel sequence of transmitter T2 forms a ramp in the opposite direction to the channel sequence of transmitter T1. Such opposing ramps are only possible with an even number of channels, as otherwise there would be two points in time at which both transmitters use the same channel, as a result of which Rule b) would be breached.

Finally, Example 10 shows channels 0 to 15 with N=32 for 16 transmitters. All channels are occupied at every point in time. If one of the 16 transmitters is fixed, the other 15 transmitters can be located simultaneously with this hopping scheme. If Rule b) must not be breached, there can never be more transmitters than channels in a hopping scheme. The minimum number of transmitters is 2, because there must always be at least one transmitter with a known position.

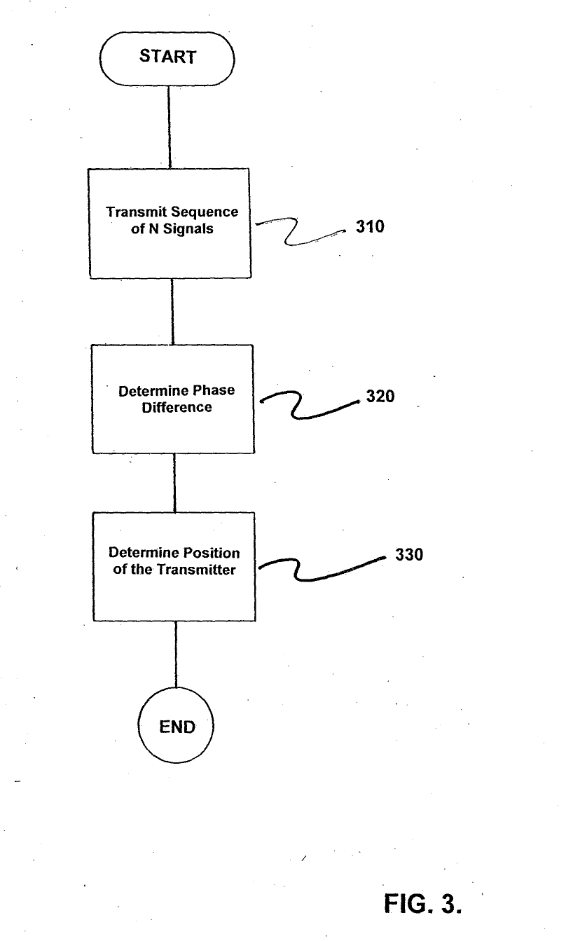

FIG. 3 is a flow chart illustrating a method for locating at least one transmitter using a further transmitter and at least two receivers in accordance with the invention. The method comprises transmitting from each transmitter a sequence of N signals which are received by the at least two receivers, as indicated in step 310. Here, the sequence of N signals are transmitted on defined channels which are selected in accordance with a prescribed hopping scheme, as indicated in step 320. Next, a phase difference between the received signals of each transmitter is determined in each of the at least two receivers for each defined channel. Next, a position of the at least one transmitter to be located is determined based on the phase differences between the received signals of each transmitter, as indicated in step 330.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A method for locating at least one transmitter using a further transmitter and at least two receivers, comprising:
transmitting from each transmitter of the at least one transmitter and the further transmitter a sequence of N signals which are received by the at least two receivers, the sequence of N signals being transmitted on defined channels which are selected in accordance with a prescribed hopping scheme;
determining a phase difference between the received signals of each transmitter in each of the at least two receivers for each defined channel; and
determining a position of the at least one transmitter to be located based on the phase differences between the received signals of the each transmitter.

15. The method according to claim 14, wherein the prescribed hopping scheme comprises respective dedicated hopping schemes with N entries for the at least one transmitter and the further transmitter;
wherein the hopping schemes are symmetrical about their midpoint;
wherein the sequence of signals are transmitted at defined transmission times and the transmission times within the dedicated hopping scheme have a constant time interval between each hop;
wherein the sequence of signals comprise a carrier signal having a frequency which is prescribed by each channel, and a data stream modulated thereon; and
wherein for each transmitter a difference between the phase of the data stream and the phase of the carrier signal of each defined channel is constant.

16. The method according to claim 15, wherein a same one of the defined channels is never used by two transmitters at a same time.

17. The method according to claim 15, wherein the respective hopping schemes of the at least one transmitter and the further transmitter contain identical defined channels.

18. The method according to claim 16, wherein the respective hopping schemes of the at least one transmitter and the further transmitter contain identical defined channels.

19. The method according to claims 15, wherein a linear frequency ramp is formable with all of the defined channels used in one of the hopping schemes; and wherein two mean frequencies corresponding to adjacent defined channels have a constant frequency spacing.

20. The method according to claim 16, wherein a linear frequency ramp is formable with all of the defined channels used in one of the hopping schemes; and wherein two mean frequencies corresponding to adjacent defined channels have a constant frequency spacing.

21. The method according to claim 17, wherein a linear frequency ramp is formable with all of the defined channels used in one of the hopping schemes; and wherein two mean frequencies corresponding to adjacent defined channels have a constant frequency spacing.

22. The method according to claim 14, wherein positions of the at least two receivers and the further transmitter are known.

23. The method according to claim 14, wherein N is an even integer and is greater than or equal to 4.

24. The method according to claim 14, wherein said determining the position of the at least one transmitter to be located further comprises:
determining a phase position at each receiver of the at least two receivers for each of the defined channels and for each signal received from one of the at least one transmitter and the further transmitter;
calculating, at each of the at least two receivers, a phase difference of the determined phase positions for each of the defined channels;
calculating, at each of the at least two receivers, a total phase difference value from a difference of the phase differences for each of the defined channels; and
determining a transit time difference (τ₀) by solving an over-determined system of equations:
Δφ^{tot}(kₙ)=−4π·f(kₙ)·τ₀+φ₀, where
Δφ^{tot}(kₙ) is the total phase difference value for one channel kₙ of the channels,
f(kₙ) is a mean frequency of the one channel, and
φ₀ is a constant.

25. The method according to claim 24, further comprising:
determining an arrival time at each of the at least two receivers for each of the defined channels and for each individual signal received from each transmitter;
calculating the transit time difference for each of the at least two receivers for each of the defined channels from the calculated arrival time;
calculating a transit time difference value from the transit time differences for each of the defined channels; and
determining an averaged transit time difference value from the transit time difference values by averaging over all of the defined channels used.

26. The method according to claim 25, further comprising:
selecting a solution of the over-determined system of equations which is closest to the averaged transit time difference value.

27. The method according to claim 26, wherein a distance of the at least one transmitter to be located from the further transmitter is determined in accordance with a relationship:
d_{T1,T2}=τ₀·c,
where (τ₀) is the transit time difference and c is speed of light.

28. The method according to claim 24, wherein phase positions of those signals which have been transmitted from one transmitter of the at least one transmitter and the further transmitter on a same one of the defined channels are arithmetically averaged in each of the at least two receivers.

29. The method according to claim 24, wherein arrival times of those signals which have been transmitted from one transmitter of the at least one transmitter and the further transmitter on a same one of the defined channels are arithmetically averaged in each of the at least two receivers.
